(19) United States
(12) Patent Application Publication
(10) Pub. No.: US 2016/0060912 A1
(43) Pub. Date: Mar. 3, 2016

(54) Vehicle Lock And Personal Protection Baton

(71) Applicants: David Mark Matthews, Westville, OK (US); Regina B. McConnell, Lincoln, AR (US)

(72) Inventors: David Mark Matthews, Westville, OK (US); Regina B. McConnell, Lincoln, AR (US)

(21) Appl. No.: 14/840,817

(22) Filed: Aug. 31, 2015

Related U.S. Application Data
(60) Provisional application No. 62/044,442, filed on Sep. 2, 2014.

(51) Int. Cl. E05B 85/00; F41B 15/02

(52) U.S. Cl. CPC E05B 85/00; F41B 15/027

(57) ABSTRACT

A vehicle lock and personal protection baton uses a telescoping construction to combine an elongated base and an elongated extension. The elongated extension slides within the elongated base in order to switch between configurations, specifically for use as a lock or for use as a protection baton. A locking mechanism couples the elongated extension with the elongated base, and a user can easily twist the locking mechanism to allow or prevent sliding of the elongated extension with respect to the elongated base. The elongated extension includes an end segment with one or more intermediate segments to allow for greater length. The end segment is slidably engaged with the intermediate segment, allowing the end segment to telescope with the intermediate segment. A first brace and second brace are connected to opposite ends of the telescoping body and inserted between a door frame and handle to lock a vehicle from the interior.

The current application claims a priority to the U.S. Provisional Patent application Ser. No. 62/044,442 filed on Sep. 2, 2014.

### FIELD OF THE INVENTION

The present invention relates generally to a telescoping apparatus which can be converted between configurations for use as a vehicle lock and a personal protection baton.

### BACKGROUND OF THE INVENTION

There are a large number of services and products designed to address personal security within or related to vehicles. Standard door locks are perhaps one of the most ubiquitous examples of such an apparatus, limiting vehicle entry to persons who possess the appropriate key. While this is sufficient to deter casual thieves and other criminals, it is an inadequate protection in a number of scenarios.

Some examples of such scenarios relate to operators of fleet vehicles, i.e. truck drivers. A common practice is to provide a standard key that provides access to any of the vehicles in the fleet, rather than providing individual keys for each specific vehicle. As a result, at any given time there are a number of persons with access to a vehicle. This can be of concern to truck drivers, who cannot be fully assured that someone else with the key will attempt to access the truck cabin. This can prove especially dangerous when the driver is sleeping in the cab, which is when they are most vulnerable to attempted thefts or worse.

The present invention helps to improve personal security by providing a compact telescoping device that can brace the vehicle doors from the interior. By simply extending a telescoping body and inserting a brace between each interior door handle and door frame, the present invention creates tension that resists opening from the outside. This ensures that, when occupied, the vehicle is inaccessible to others, even if they have the proper key. As an additional safety feature, the present invention can be switched into a compacted configuration and effectively wielded as a baton. This allows the vehicle operator to protect themselves from physical assault, if a situation escalates that far. While there are other personal defense items available, an advantage of the present invention is that it will always be available, given the multipurpose use; a user is less likely to forget the present invention in their home and will normally have the present invention nearby and easily accessible when needed.

The present invention is not limited to use with trucks; it can be utilized in conjunction with cars, mobile homes, and other vehicles that are accessed via doors. The present invention can even be utilized while driving, with the telescoping body extending over the driver and passenger's laps to engage with the interior door handles; this helps to protect users in a variety of situations, such as potential carjacking attempts.

Ultimately, it is a goal of the present invention to serve as a vehicle anti break in device and personal defense baton. The present invention provides both vehicular and personal security.

### BRIEF DESCRIPTION OF THE DRAWINGS

FIG. 1 is a left-side perspective view showing the present invention in a contracted configuration.

FIG. 2 is a right-side perspective view showing the present invention in the contracted configuration.

FIG. 3 is a front view showing the present invention in the contracted configuration.

FIG. 4 is a top plan view showing the present invention in the contracted configuration.

FIG. 5 is an exploded left-side perspective view showing the present invention.

FIG. 6 is an exploded right-side perspective view showing the present invention.

FIG. 7 is a left-side perspective view showing the present invention in an expanded configuration.

FIG. 8 is a right-side perspective view showing the present invention in the expanded configuration.

FIG. 9 is a front view showing the present invention in the expanded configuration.

FIG. 10 is a top plan view showing the present invention in the expanded configuration.

### DETAIL DESCRIPTIONS OF THE INVENTION

All illustrations of the drawings are for the purpose of describing selected versions of the present invention and are not intended to limit the scope of the present invention.

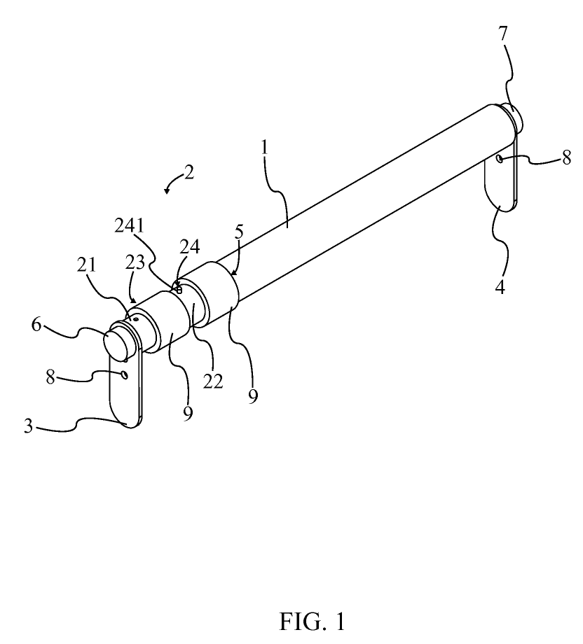

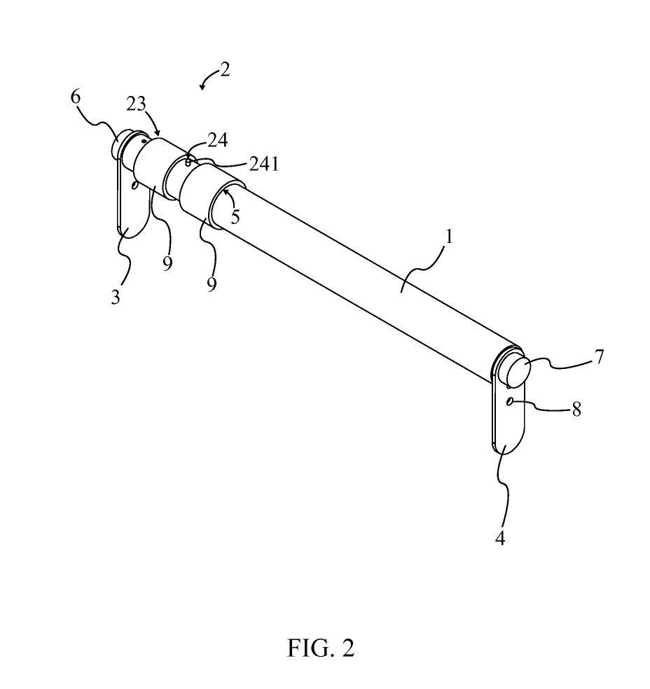

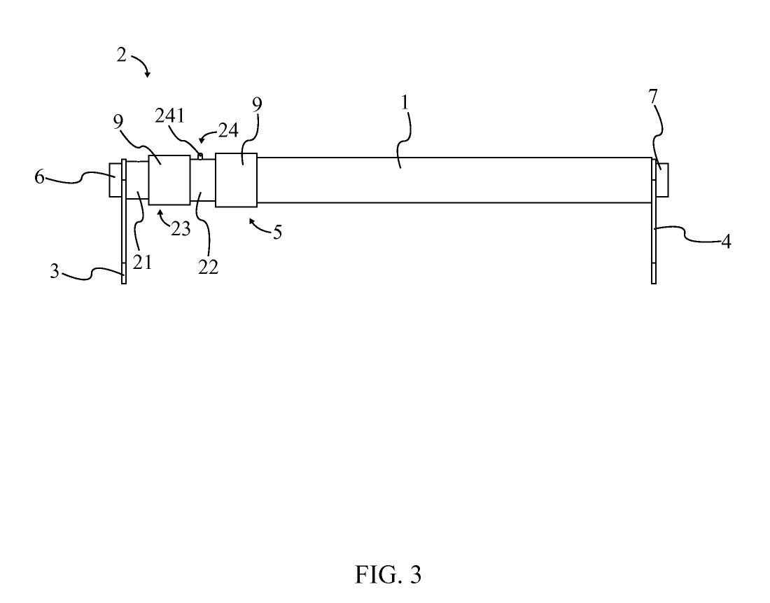

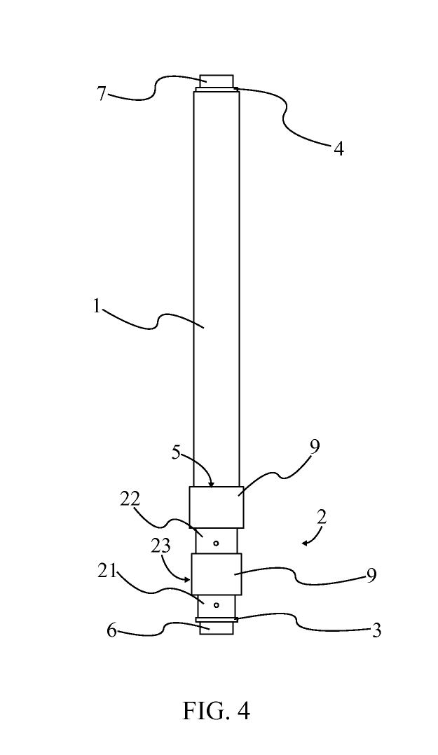

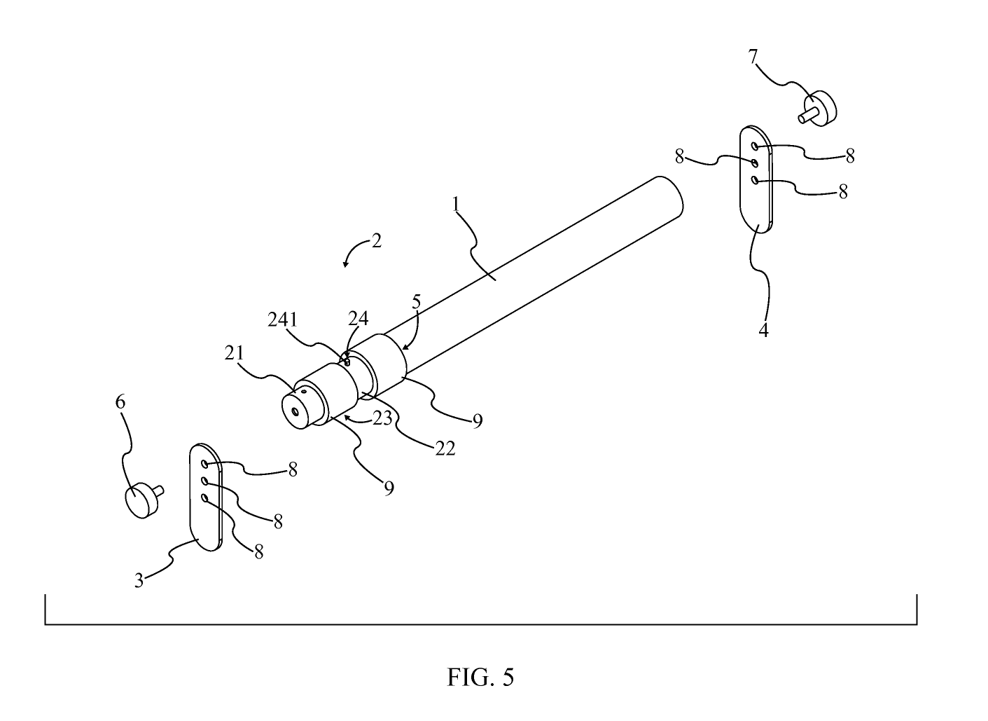

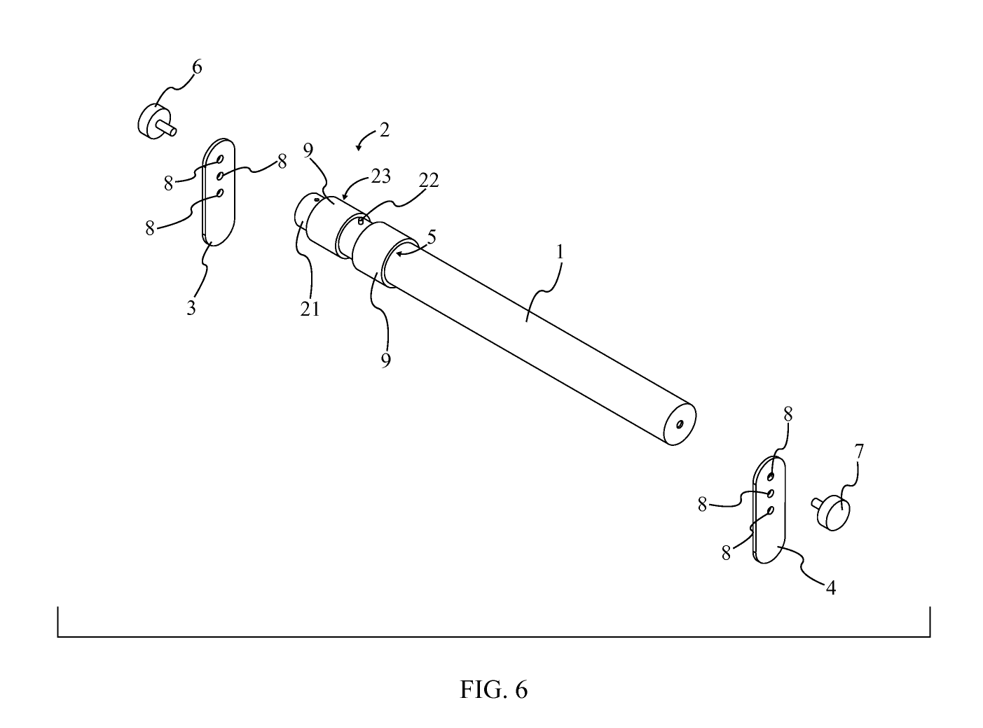

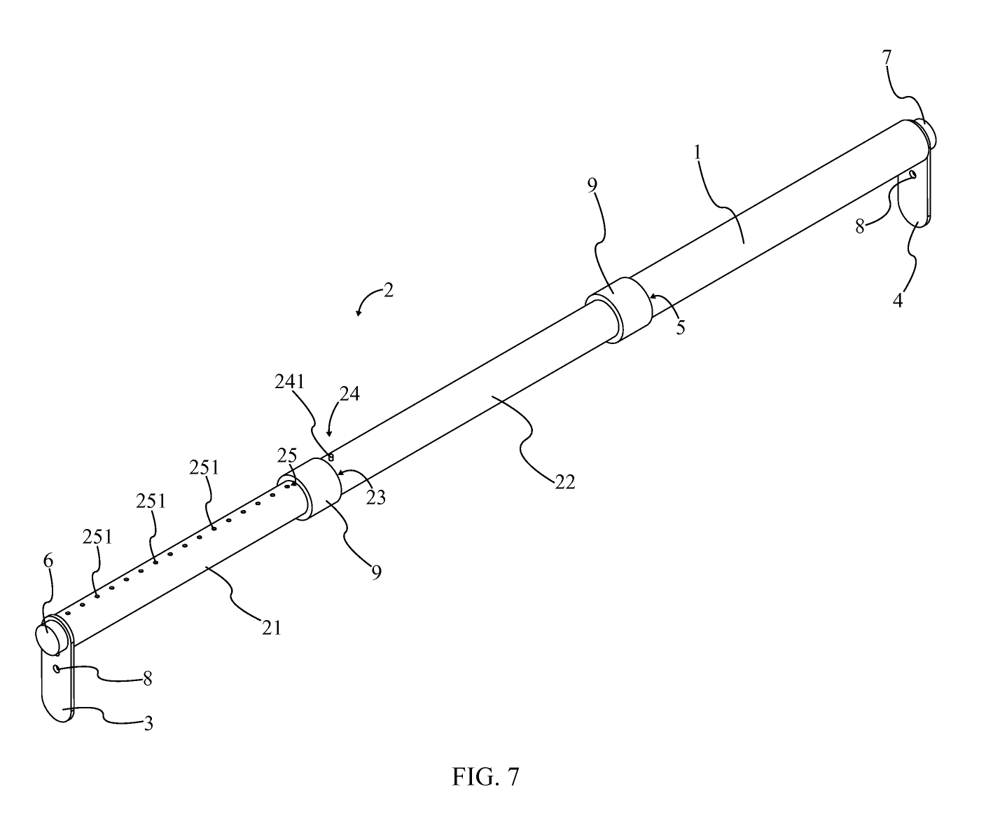

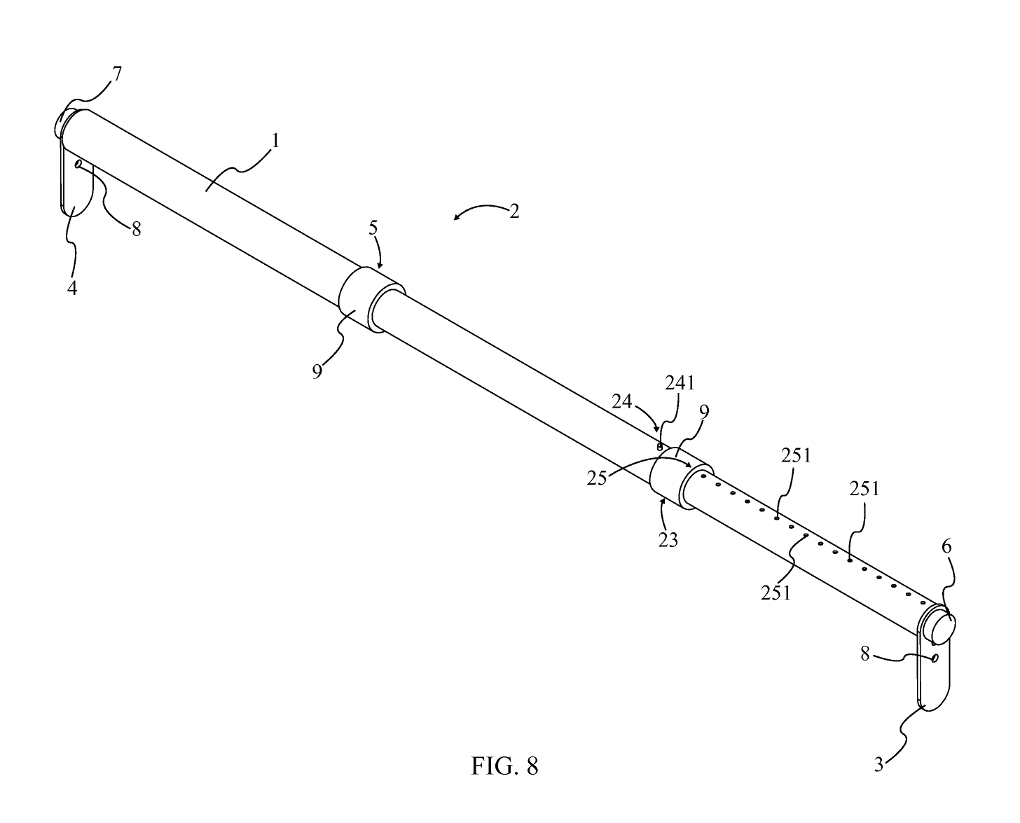

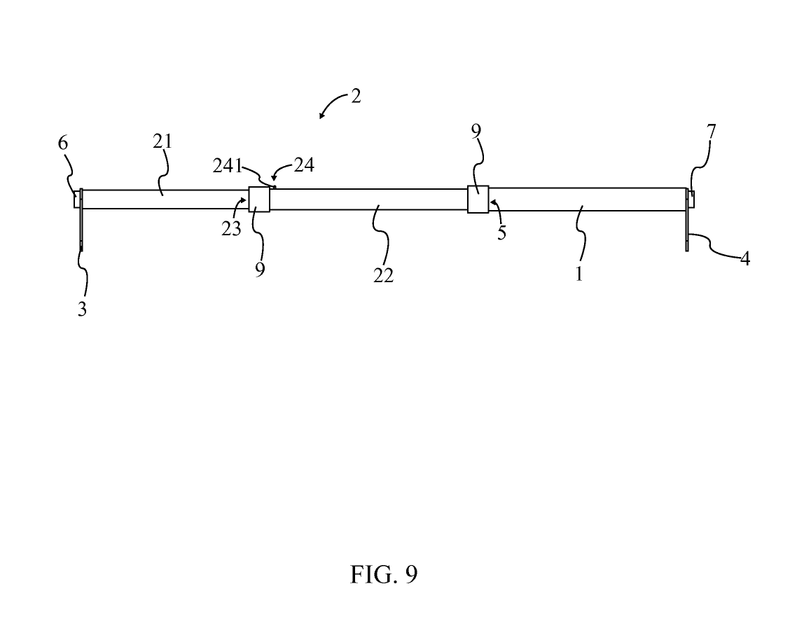

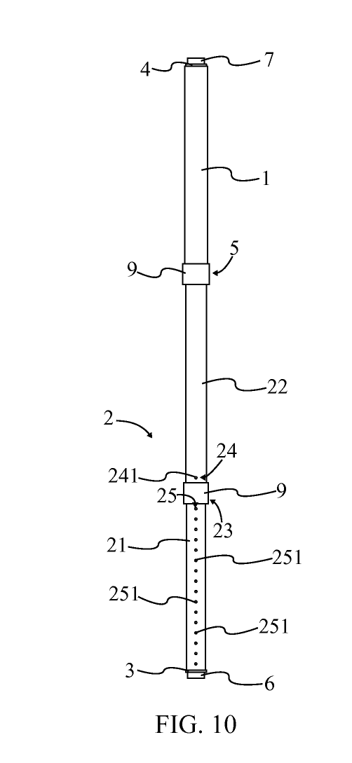

The present invention is a multipurpose vehicle lock and personal protection baton. A telescoping construction allows the present invention to be switched between configurations; in one configuration the present invention serves as a lock that prevents vehicle doors from being opened from the outside. In a second configuration the present invention serves as a compact tool that can be wielded as a personal defense weapon or as a tool for more utilitarian purposes, such as clearing snow and ice from vehicle tires. The present invention comprises an elongated base 1, an elongated extension 2, a first brace 3, a second brace 4, and a locking mechanism 5. The elongated base 1 and elongated extension 2 combine to form a telescoping body, with the elongated extension 2 telescoping into and out of the elongated base 1. This allows for the length of the present invention to be adjusted. The first brace 3 and second brace 4 are connected at opposite ends of the present invention, allowing them to be engaged with the interior handle of a vehicle door in order to prevent the door from being opened from the outside. The locking mechanism 5 couples the elongated base 1 and elongated extension 2 to each other, joining the two components in a secure fashion. The present invention is shown in a contracted configuration (i.e. the personal defense configuration) in FIG. 1-FIG. 6 and in an extended configuration in FIG. 7-FIG. 10.

To enable the telescoping nature of the present invention, the elongated base 1 is sleeves the elongated extension 2, with the elongated base 1 and elongated extension 2 being slidably engaged with each other. As a result the elongated extension 2 is afforded linear movement relative to the elongated base 1. To increase the length of the present invention (allowing it to be utilized as a vehicle lock), the elongated extension 2 can be moved out of the elongated base 1. To decrease the length of the present invention (allowing it to be utilized as a personal protection baton and general purpose tool), the elongated extension 2 can be moved into the elongated base 1. The elongated extension 2 comprises one or more segments; if the elongated extension 2 is a single segment it comprises an end segment 21; if the elongated extension 2 comprises multiple segments, the elongated extension 2 comprises the end segment 21 and an intermediate segment 22. The end segment 21 is sleeved by the intermediate segment 22, with the two segments being slidably engaged with each other. Similarly, the intermediate segment 22 is sleeved by the elongated base 1. Potentially, multiple intermediate sections may be provided to increase the fully extended length of the present invention, as might be necessary for vehicles with exceptionally wide cabins (e.g. tractor trailers). As the individual segments of the present invention can be provided with varying length, there is no set number of intermediate sections that are required. In the illustrated embodiment, a single intermediate segment 22 is used; in combination with the elongated base 1 and end segment 21 this provides sufficient length to secure the cabin of a non-commercial passenger vehicle, e.g. a sedan. For vehicles with larger cabins, e.g. a tractor trailer, two intermediate segments 22 can be utilized to provide the necessary length in an expanded configuration. In such an embodiment, an addition locking mechanism 5 is provided to couple the two intermediate segments 22 to each other in a telescoping manner.

As the present invention is usable in two configurations, those being the expanded locking configuration and contracted baton configuration, the locking mechanism 5 is provided to help secure the present invention in the desired configuration. The locking mechanism 5, which couples the elongated base 1 with the elongated extension 2, is concentrically aligned with said elongated base 1 and elongated extension 2. The locking mechanism 5 cuffs adjacent ends of the elongated base 1 and elongated extension 2, such that by engaging or disengaging the locking mechanism 5 a user is able to prevent or enable sliding of the elongated extension 2 with respect to the elongated base 1. In the preferred embodiment, the locking mechanism 5 is a clutch lock collar 9; such a lock is preferable as it allows a user to easily engage or disengage the locking mechanism 5 via rotation. A clutch lock collar 9 of the preferred embodiment has a knurled outer shell which is threadibly engaged with a split inner sleeve; by rotating the knurled outer shell, the inner sleeve is tightened or loosened. This interaction allows a user to enable and disable telescoping of the present invention. Potentially, other mechanisms could be implemented for the locking mechanism 5, examples of which include clamp locks and cam locks.

An extension locking mechanism 23 is also provided in order to couple the end segment 21 to the intermediate segment 22. This extension locking mechanism 23 is concentrically aligned with the intermediate segment 22 and end segment 21, cuffing the two adjacent segments in order to join them. The extension locking mechanism 23 thus allows for sliding of the end segment 21 relative to the intermediate segment 22, akin to how the first locking mechanism 5 allows for sliding of the elongated extension 2 relative to the elongated base 1. As with the first locking mechanism 5, the extension locking mechanism 23 is preferably a clutch lock collar 9, though alternative locking mechanisms including clamp locks and cam locks can be used without deviating from the scope of the present invention.

To further secure the present invention in a desired configuration, an auxiliary means of engaging different components of the present invention can be utilized. To facilitate this, the elongated extension 2 comprises a latching mechanism 24 and a plurality of latch receptacles 25. The latching mechanism 24 is mounted to the intermediate section and positioned adjacent to the end segment 21. The plurality of latch receptacles 25 is linearly positioned along the end segment 21. The positioning of these components allows the latching mechanism 24 to engage with the plurality of latch receptacles 25. The latching mechanism 24 is preferably a spring-loaded pin 241; the corresponding plurality of latch receptacles 25 is a plurality of apertures 251. The spring-loaded pin 241 is engaged with one of the plurality of latch receptacles 25. The spring-loaded pin 241 thus traverses through a selected aperture 251 and thus prevents linear movement of the end segment 21 relative to the intermediate segment 22. The selected aperture 251 can be any of the plurality of latch receptacles 25; the end segment 21 can thus be extended to a desired length relative to the intermediate segment 22. A user can change the length of the present invention by disengaging the spring-loaded pin 241 from a currently engaged aperture 251, aligning the spring-loaded pin 241 with another aperture 251, and then engaging the spring-loaded pin 241 to other aperture 251.

As mentioned, the latching mechanism 24 and plurality of latch receptacles 25 help to further secure the present invention in a selected configuration; they are not required in a basic embodiment of the present invention. In other words, the latching mechanism 24 supplements the locking mechanism 5 in embodiments where the latching mechanism 24 is used.

To allow the present invention to lock a vehicle from the interior, the first brace 3 and the second brace 4 are connected to opposite ends of the telescoping body that includes the elongated base 1 and the elongated extension 2. The first brace 3 and the second brace 4 are preferably mounted to their corresponding elongated base 1 and elongated extension 2 by a first knob 6 and a second knob 7, respectively. There are a plurality of mounting holes 8 on both the first brace 3 and the second brace 4, allowing a user to adjust the position of each brace by engaging the first knob 6 and the second knob 7 with different mounting holes 8 from the plurality of mounting holes 8. The first brace 3 and second brace 4 can be oriented at a desired angle; for example, in one embodiment they could be given a 45 degree angle while in another embodiment they could be configured to be perpendicular to the telescoping body.

The elongated base 1 and the elongated extension 2 each comprise a mount-receptacle, a threaded insert which allows for the corresponding first knob 6 and second knob 7 to be screwed into the appropriate part of the telescoping body. The first knob 6 and the second knob 7, along with the first brace 3 and second brace 4, can thus easily be detached from the telescoping body or repositioned relative to the telescoping body.

Reiterating the application of the first brace 3 and the second brace 4, they interact with the telescoping body to allow the present invention to be used to lock a vehicle cabin from the interior. By expanding the telescoping body, the first brace 3 can be positioned between the handle and door frame of the driver-side door while the second brace 4 can be positioned between the handle and door frame of the passenger-side door. Provided the telescoping body has been properly locked, the first brace 3 and second brace 4 prevent persons outside the vehicle from pulling the doors open; each door is effectively anchored to the opposite door by the present invention and thus incapable of opening. A person within the cab is thus protected against potential intruders. This protection is applicable to a number of scenarios, including truck drivers whose cab can be accessed by a shared fleet key or persons driving through high crime areas where auto-thefts are more probable. Effectively, the present invention serves as an additional layer of security beyond the standard door locks found in cars and trucks.

A further layer of protection is provided via the present invention's second configuration. When the telescoping body is compacted, the present invention is easily grasped and wielded as a personal defense baton. The present invention, in the compacted configuration, finds further use as a tool which is capable of scraping debris (e.g. ice, snow, and mud) from a car. Further applications for the present invention in the compacted configuration are also possible; the aforementioned scenarios are just a few example applications and do not preclude use of the present invention in other situations.

Ultimately, the illustrated embodiment and any alternative embodiments of the present invention utilize a telescoping body in conjunction with a pair of braces. The telescoping construction of the present invention allows it to be manipulated into a locking configuration or a personal defense configuration. In the locking configuration, the present invention helps secure a vehicle from the interior in order to prevent others from entering while the vehicle is occupied. In the personal defense configuration the present invention can be utilized as a baton in self-defense. These primary applications of the present invention do not preclude other uses as potentially envisioned by users.

Although the invention has been explained in relation to its preferred embodiment, it is to be understood that many other possible modifications and variations can be made without departing from the spirit and scope of the invention as hereinafter claimed.

What is claimed is:

1. A vehicle lock and personal protection baton comprises:
an elongated base;
an elongated extension;
a first brace;
a second brace;
a locking mechanism;
the elongated extension being sleeved by the elongated base;
the elongated base and the elongated extension being slidably engaged with each other;
the locking mechanism being mechanically integrated into the slidable engagement between the elongated base and the elongated extension;
the first brace being adjacently connected to the elongated base;
the second brace being adjacently connected to the elongated extension;
the first brace being positioned opposite the elongated extension along the elongated base; and
the second brace being positioned opposite the elongated base along the elongated extension.

2. The vehicle lock and personal protection baton as claimed in claim 1 comprises:
a first knob;
a second knob;
the first brace and the second brace each comprise a plurality of mounting holes;
the first knob traversing into the elongated base through one of the plurality of mounting holes of the first brace; and
the second knob traversing into the elongated extension through one of the plurality of mounting holes of the second brace.

3. The vehicle lock and personal protection baton as claimed in claim 2 comprises:
the first knob being threadibly engaged with the elongated base; and
the second knob being threadibly engaged with the elongated extension.

4. The vehicle lock and personal protection baton as claimed in claim 1 comprises:
an extension locking mechanism;
the elongated extension comprises an intermediate segment and an end segment;
the intermediate segment being sleeved by the elongated base;
the elongated base and the intermediate segment being slidably engaged with each other;
the end segment being sleeved by the intermediate segment;
the intermediate segment and the end segment being slidably engaged with each other; and
the extension locking mechanism being mechanically integrated into the slidable engagement between the intermediate segment and the end segment.

5. The vehicle lock and personal protection baton as claimed in claim 4 comprises:
the elongated extension comprises a latching mechanism and a plurality of latch receptacles;
the latching mechanism being mounted to the intermediate segment;
the latching mechanism being positioned adjacent to the end segment;
the plurality of latch receptacles being linearly positioned along the end segment; and
the latching mechanism being selectively engaged with an individual latch receptacle from the plurality of latch receptacles.

6. The vehicle lock and personal protection baton as claimed in claim 5 comprises:
the latching mechanism being a spring-loaded pin;
the plurality of latch receptacles being a plurality of apertures;
the plurality of apertures perpendicularly traversing into the end segment; and
the spring-loaded pin being aligned with the individual latch receptacle.

7. The vehicle lock and personal protection baton as claimed in claim 4 comprises:
the extension locking mechanism being selectively engaged with the intermediate segment and the elongated segment, wherein the extension locking mechanism enables or disables sliding of the end segment within the intermediate segment.

8. The vehicle lock and personal protection baton as claimed in claim 4 comprises:
the extension locking mechanism being a clutch lock collar; and
the clutch lock collar being laterally positioned around the intermediate segment and the end segment.

9. The vehicle lock and personal protection baton as claimed in claim 1 comprises:
the locking mechanism being selectively engaged with the elongated base and the elongated extension, wherein the locking mechanism enables or disables sliding of the elongated extension within the elongated base.

10. The vehicle lock and personal protection baton as claimed in claim 1 comprises:
the locking mechanism being a clutch lock collar; and
the clutch lock collar being laterally positioned around the elongated base and the elongated extension.

11. A vehicle lock and personal protection baton comprises:
an elongated base;
an elongated extension;
a first brace;
a second brace;
a locking mechanism;
an extension locking mechanism;
the elongated extension comprises an intermediate segment and an end segment;
the elongated extension being sleeved by the elongated base;
the elongated base and the elongated extension being slidably engaged with each other;
the locking mechanism being mechanically integrated into the slidable engagement between the elongated base and the elongated extension;
the elongated base and the intermediate segment being slidably engaged with each other;
the intermediate segment and the end segment being slidably engaged with each other;
the extension locking mechanism being mechanically integrated into the slidable engagement between the intermediate segment and the end segment;
the first brace being adjacently connected to the elongated base;
the second brace being adjacently connected to the elongated extension;
the first brace being positioned opposite the elongated extension along the elongated base; and
the second brace being positioned opposite the elongated base along the elongated extension.

12. The vehicle lock and personal protection baton as claimed in claim 11 comprises:
a first knob;
a second knob;
the first brace and the second brace each comprise a plurality of mounting holes;
the first knob traversing into the elongated base through one of the plurality of mounting holes of the first brace;
the second knob traversing into the elongated extension through one of the plurality of mounting holes of the second brace;
the first knob being threadibly engaged with the elongated base; and
the second knob being threadibly engaged with the elongated extension.

13. The vehicle lock and personal protection baton as claimed in claim 11 comprises:
the intermediate segment being sleeved by the elongated base; and
the end segment being sleeved by the intermediate segment.

14. The vehicle lock and personal protection baton as claimed in claim 11 comprises:
the elongated extension comprises a latching mechanism and a plurality of latch receptacles;
the latching mechanism being mounted to the intermediate segment;
the latching mechanism being positioned adjacent to the end segment;
the plurality of latch receptacles being linearly positioned along the end segment; and
the latching mechanism being selectively engaged with an individual latch receptacle from the plurality of latch receptacles.

15. The vehicle lock and personal protection baton as claimed in claim 14 comprises:
the latching mechanism being a spring-loaded pin;
the plurality of latch receptacles being a plurality of apertures;
the plurality of apertures perpendicularly traversing into the end segment; and
the spring-loaded pin being aligned with the individual latch receptacle.

16. The vehicle lock and personal protection baton as claimed in claim 11 comprises:
the extension locking mechanism being selectively engaged with the intermediate segment and the elongated segment, wherein the extension locking mechanism enables or disables sliding of the end segment within the intermediate segment.

17. The vehicle lock and personal protection baton as claimed in claim 11 comprises:
the extension locking mechanism being a clutch lock collar; and
the clutch lock collar being laterally positioned around the intermediate segment and the end segment.

18. The vehicle lock and personal protection baton as claimed in claim 11 comprises:
the locking mechanism being selectively engaged with the elongated base and the elongated extension, wherein the locking mechanism enables or disables sliding of the elongated extension within the elongated base.

19. The vehicle lock and personal protection baton as claimed in claim 11 comprises:
the locking mechanism being a clutch lock collar; and
the clutch lock collar being laterally positioned around the elongated base and the elongated extension.
